(19) United States
(12) Patent Application Publication
(10) Pub. No.: US 2024/0239061 A1
(43) Pub. Date: Jul. 18, 2024

(54) Method of Manufacturing a Component from a Composite Material with Locally Different Thicknesses

(71) Applicant: Premium Aerotec GmbH, Augsburg (DE)

(72) Inventors: Marc Hollmann, Hambergen (DE); Angelos Miaris, Bremen (DE); Henning Hayen, Elsfleth (DE); Lukas Roeger, Varel (DE); Matthias Uellendahl, Gevelsberg (DE); Tanja Frese, Horstedt (DE); Lenard Wohlsen, Bremen (DE); Klaus Edelmann, Bremen (DE)

(73) Assignee: Premium Aerotec GmbH, Augsburg (DE)

(21) Appl. No.: 18/141,588

(22) Filed: May 1, 2023

(30) Foreign Application Priority Data
May 2, 2022 (DE) 10 2022 110 728.0

(51) Int. Cl. B29C 70/54; B29C 33/68; B29C 51/14; B29C 70/48; B29K 105/08

(52) U.S. Cl. CPC B29C 70/545; B29C 33/68; B29C 51/14; B29C 70/48; B29C 2793/0018; B29K 2105/0872

(57) ABSTRACT

A method for producing a component having locally different thicknesses includes the steps of providing a first laminate, arranging a release layer on the first laminate, providing a second laminate with a second surface correlating with the first surface of the first laminate, placing the second laminate with the second surface on the first surface so that the release section is enclosed, joining the first with the second laminate by heating and/or pressing, guiding a cutting tool along one release section correlating with the release section, and so that the separating section is included, joining the first to the second laminate by heating and/or pressing, guiding a cutting tool along one contour in the second laminate that correlates with the separating section, so that one segment of the second laminate is completely detached, and removing the detached segment so that a recess is formed in each case.

### TECHNICAL AREA

The present description concerns a method for manufacturing a component from a complex composite material with locally different thicknesses.

### TECHNICAL BACKGROUND

Numerous manufacturing processes are known for the production of assemblies and complex structures from a composite material, such as a fiber-reinforced plastic. Components with a uniform thickness are generally easier to manufacture than components with recesses, pockets or locally varying thicknesses. For the local arranging of pockets in components made of a composite material, it is known to produce the relevant components with a uniform thickness in order to then remove material in areas by cutting tools to carve out the pockets. In the case of modern, high-strength composite materials, however, the cutting tool is subject to heavy stress or wear and the machining process is time-consuming. Different thicknesses in components produced using the RTM method or from prepregs are known, but this can result in problematic flow front curves of the resin or uneven temperature gradients. Pronounced thickness ratios of 1:2 or 1:3 are therefore problematic. Consequently, the cost of producing a component with pockets or recesses from a composite material is expensive.

### DESCRIPTION

It is therefore an object of the invention to provide a method or a system for producing a component from a composite material with locally different thicknesses, which can be carried out quickly and at low cost.

The problem is solved by a method for manufacturing a component from a complex composite material with locally different thicknesses with the features of the independent claim 1. Advantageous embodiments and further embodiments of the invention can be derived from the subclaims and the following description.

A method for producing a component from a composite material having locally different thicknesses is provided, comprising the steps of providing a first laminate arrangement, arranging a release layer on at least one separating portion of a first surface of the first laminate arrangement, providing a second laminate arrangement having a second surface correlating with the first surface of the first laminate arrangement, placing the second laminate arrangement with the second surface on the first surface of the first laminate arrangement so that the at least one separating portion is enclosed, joining the first laminate arrangement with the second laminate arrangement by heating and/or pressing, guiding a cutting tool along at least one separating portion correlating with the at least one separating portion so that the at least one separating portion is enclosed, so that the at least one separating portion is enclosed, joining the first laminate arrangement to the second laminate arrangement by heating and/or pressing, guiding a cutting tool along at least one contour in the second laminate arrangement which correlates with the at least one separating portion, so that at least one segment of the second laminate arrangement is completely detached, and removing the at least one detached segment so that a recess is formed in each case.

The component can be manufactured with different fiber-matrix systems, with which unidirectional fibers, which are preferably endless, fabrics and/or non-crimp fabrics in the form of several layers are integrated into a matrix material and thus form a material composite. The fibers and the matrix material can be selected depending on the area of application and the expected mechanical and thermal load.

In one embodiment, for example, reactive resins could be used that harden under pressure and heat and form duromers. The two laminate arrangements could then be produced using prepregs, for example, and pre-cured if necessary. However, it is also conceivable to use resin-infiltrated layer structures that can be infiltrated using an RTM or vacuum infusion process. The first laminate arrangement can comprise a preform (also known as a “preform”).

However, thermoplastic matrix materials are also conceivable, such as PPS, PEEK, PEKK, PEI, PAEK and others. The two laminate arrangements are then preferably already fully impregnated subcomponents, which can be joined together by placing one on top of the other and heating. In addition, such laminate arrangements can be formed by a thermoforming process. During thermoforming, the two laminate arrangements can be joined together so that the release layer is enclosed between them.

In a simple variant, the first laminate arrangement could be flat and have a uniform thickness. The flat shape can be single or multi-curved. It has a first surface that forms a connection with the second surface of the second laminate arrangement.

The second laminate arrangement could be made in the same way and comprise a continuous arrangement of several layers of unidirectional fibers, a fabric and/or scrim. In principle, the second laminate arrangement could also comprise fibers that are distributed or oriented in a different manner than in the first laminate arrangement. The second surface of the second laminate arrangement is to be formed in such a way that it can be laid flush with the first surface.

The two laminate arrangements each have a thickness which together provide the thickness of the desired component. A core of the invention is to provide a release layer locally between the two laminate arrangements where a recess, a pocket or an arbitrarily reduced thickness is desired. The release layer is designed to prevent the two laminate arrangements from joining in the relevant separation section.

To produce a closed component from the composite material, the two laminate arrangements are bonded together, for example by applying heat and/or pressure to the two components lying on top of each other. Depending on the matrix material used, the two laminate arrangements could harden together or fuse together by softening or melting the matrix material at the interface between the first surface and the second surface. However, since the release layer is arranged locally, this joining process is prevented locally, so that in the separation section defined by the release layer, the two laminate arrangements remain separated even after joining. By guiding the cutting tool along a contour that correlates with the release layer, the second laminate arrangement is separated locally. Due to the lack of connection to the underlying first laminate arrangement, cutting out the contour is sufficient to completely detach the intended segment of the second laminate arrangement from the first laminate arrangement. After removing the segment, for example by hand or using a suction cup, the desired recess is created in the component.

By guiding the cutting tool only on a single, closed contour, wear on the cutting tool can be reduced and the time required to produce the recess can also be significantly reduced compared to conventional methods. The costs for tool use are significantly reduced. Furthermore, the release layer also prevents the cutting tool from damaging the fiber structure of the first laminate arrangement or the part of the fibers remaining in the component at the location of the reduced thickness.

In an advantageous embodiment, the first laminate arrangement and the second laminate arrangement have a fiber-reinforced plastic comprising fibers from a group of fibers, the group comprising carbon fibers, glass fibers, aramid fibers and mixtures thereof. The fibers extend in at least one direction and preferably in several directions at an angle to one another. In particular, the fibers are formed in the form of fiber bundles, fabrics or scrims, which are formed as individual surfaces. The particular advantages of the method arise in particular with endless fibers, as the release layer arranged according to the invention can reliably prevent fibers in a remaining layer from being damaged. Instead of continuous fibers, however, short fibers and/or non-woven fiber material, but also woven material, could also be used.

In an advantageous embodiment, the release layer is incorporated into the first laminate arrangement or the second laminate arrangement so that it is flush with the adjacent material of the first or second laminate arrangement on the first surface or second surface. The first laminate arrangement or the second laminate arrangement could already be prefabricated with the release layer. In this case, the release layer is not attached to the relevant surface of the first laminate arrangement or the second laminate arrangement, but is integrated directly into the layer structure of the first or second laminate arrangement. The outward-facing surface of the relevant laminate arrangement is then flush with the adjacent material.

In an advantageous embodiment, the release layer has a thickness that corresponds to a thickness of a layer of the relevant laminate arrangement adjacent to the first surface or the second surface. The release layer can be specifically combined with an outermost layer of fibers that is adjacent to the first or second surface. In this outermost layer, fibers are removed locally and replaced by the release layer. The fibers within the separation section are therefore interrupted at the contour of the release layer. The release layer preferably adjoins the fiber ends as precisely as possible. A gap of less than a tenth of a millimeter could be tolerated between the fiber ends and the release layer. If possible, the fiber ends should be prevented from protruding into the release section so that the guided tool does not exert a tensile force on the fiber ends when the contour of the release section is cut out.

In an advantageous embodiment, the release layer comprises a plastic that is dimensionally stable at temperatures up to 250° C., preferably up to 275° C., more preferably up to 330° C. and particularly preferably up to 400° C., at least for a short time. This corresponds to a temperature to which the first laminate arrangement and the second laminate arrangement could be exposed in order to create a bond between the two laminate arrangements. In order to counteract thermally induced destruction, the material of the release layer is adapted to this.

In an advantageous embodiment, the release layer comprises an aluminum layer. No special mechanical requirements are made for the aluminum layer and conventional alloys containing magnesium, manganese, silicon and/or other elements, for example, can be used. The aluminum layer reliably prevents adhesion and at the same time provides sufficient thermal stability. This also makes it easier to precisely immerse and guide the cutting tool up to the release layer and the remaining layers underneath therefore have improved corrosion resistance. The aluminum layer can be realized as a foil and preferably as a thin sheet with a thickness of more than a tenth of a millimeter, for example about 0.3 mm. Aluminum is a comparatively soft material and is very easy to machine. When using such aluminum layers, it is easily possible to mill to the correct depth without damaging the fibers of a layer beneath the aluminum layer, which will later be on the outside of the finished component. The fibers of this layer are therefore not cut through and are completely covered with resin. The mechanical properties remain unchanged and the component remains electrically insulated due to the resin coating. This prevents galvanic corrosion of surrounding aluminum components when the component is later used.

However, other metallic materials are also conceivable for this purpose.

In an advantageous embodiment, the release layer comprises polyimide. Release films are commercially available in the form of adhesive tapes or films containing polyimide. This plastic is particularly temperature-resistant and can withstand temperatures of up to around 230° ° C. permanently and can be exposed to temperatures of up to 400° ° C. for short periods. This enables effective separation of the two laminate arrangements. The further advantage of such a polyimide film is that if the component is consolidated in a mold with a fixed cavity, i.e. an upper and lower mold made of steel, the additional film does not impair the surrounding consolidation of the two laminate arrangements if the film thickness is low before the method is executed.

The release layer can have a plastic that is temperature-resistant up to around 330° C., at least for a short time. This makes sense when processing PPS. When processing PEEK, for example, a higher temperature resistance is required and the release layer should be resistant to temperatures of up to 400° C. or slightly higher for a short time.

In an advantageous embodiment, the at least one separating section is spaced from the edges of the first laminate arrangement and the second laminate arrangement. Consequently, the pocket or recess to be produced does not protrude into an edge area of the component to be produced, but is completely surrounded on all sides by material from adjacent areas. It is therefore necessary to guide the cutting tool at right angles to the first or second surface towards the composite of the two laminate arrangements, immerse it in the material of the second laminate arrangement and then guide it along the contour. An immersion depth must be adapted to the installation depth of the release layer so that the layer structure of the first laminate arrangement is not damaged.

In an advantageous embodiment, the joining of the first laminate arrangement with the second laminate arrangement takes place in a thermoforming process. In a thermoforming process, a blank is produced from a sheet material of a thermoplastic material, brought to melting temperature in an oven and then converted into a three-dimensional shape in a molding tool with two molds adapted to one another. According to the invention, both laminate arrangements, which consist, for example, of a thermoplastic material reinforced with fibers, are provided with the release layer and heated. The laminate arrangements rest on a first of the two molds. Once the melting temperature has been reached, the second mold is pressed onto the laminate arrangements in the direction of the first mold. Both laminate arrangements bond together and enclose the release layer. The three-dimensionally formed component can then be removed from the molding tool after appropriate cooling and solidification.

As mentioned above, in an advantageous embodiment, the method according to the invention comprises forming by the thermoforming process by a molding tool. The molding tool comprises two molds, one of which may be referred to as a male mold and the other as a female mold, wherein both molds are adapted to each other such that the laminate arrangements are formed into a desired shape by pressing the two molds onto each other while enclosing the two laminate arrangements.

The invention further relates to a system for producing a component from a composite material having locally different thicknesses, comprising a molding tool having a support surface for receiving a first laminate arrangement having a first surface and a second laminate arrangement having a second surface thereon, a release material which can be applied to at least one release portion of a first surface of the first laminate arrangement as a release layer, a joining device which is designed to connect the first and second laminate arrangements lying on top of one another to the enclosed release material by the action of pressure and/or heat, and a cutting tool which is arranged movably relative to the support surface and is designed to be guided along at least one contour correlating with the at least one release section in the second laminate arrangement with a predeterminable immersion depth, so that at least one segment of the second laminate arrangement is completely released.

The system is designed to carry out the method according to the invention. The molding tool serves as a base for the first laminate arrangement and the support surface is adapted to the shape of the first laminate arrangement. The first laminate arrangement can be placed flush on the support surface. The second laminate arrangement can be placed on the first surface of the first laminate arrangement during the execution of the method. As explained above, the first surface may comprise at least one separating portion at which a release layer, referred to herein as separating material, is provided for separating the two laminate arrangements from each other. As also explained above, the release material can be placed after the first laminate arrangement has been placed or can be integrated directly into a layer adjacent to the first surface during the manufacture of the first laminate arrangement. The joining device is provided to join the two arrangements together. It is particularly advantageous if the joining device can be removed from the molding tool after joining so that the cutting tool can then move freely in order to cut the contour or contours in question out of the second laminate arrangement.

In an advantageous embodiment, the joining device is designed to exert heat and pressure directed at the support surface on the laminate arrangements. Depending on the fiber matrix system used, the joining device can be designed differently. Essentially, suitable bonding devices for common fiber matrix systems include the option of exerting pressure or temperature in order to achieve melting or curing.

In an advantageous embodiment, the joining device can be designed to perform a thermoforming process. The joining device is thus realized by the molding tool, which comprises a first and a second mold that are adapted to each other and can perform a joining and possibly a forming by pressing the two molds while enclosing the laminate arrangements with a release layer in between.

In an advantageous embodiment, the cutting tool comprises a milling tool. The cutting tool could be movably arranged above the molding tool via a 2-axis guide. The plunge groove of the milling tool is also preferably controllable. For curved components or curved laminate arrangements, it is conceivable to enable the axis of the milling tool to be tilted so that it always runs perpendicular to the local surface tangent of the outer surface of the second laminate arrangement facing away from the first laminate arrangement.

In an advantageous embodiment, the connecting device has a cover which, together with the support surface, forms a closed chamber for resin infusion if required. The cover could be flexible or rigid. A flexible cover could be a vacuum film, for example, which can be sealed on the support surface. By applying a vacuum, a pressure is created on the composite of both laminate arrangements and at the same time a resin infusion, i.e. a vacuum infusion, is operated. Alternatively, the cover could also be rigid and resin could be fed into the layer structure via an overpressure. This method is also known as the RTM method. This embodiment refers in particular to fiber-matrix systems based on a reaction-curing resin. Additional flow aids could possibly be provided to enable better distribution of the reaction resin.

In an advantageous embodiment, the support surface can be heated. The support surface could thus form part of the joining device. A cover or the like for exerting pressure on the composite of laminate arrangements could therefore be designed more simply, since the heating effect is primarily provided by the molding tool.

### BRIEF DESCRIPTION OF THE FIGURES

In the following, the enclosed drawings are used to describe embodiments in more detail. The illustrations are schematic and not to scale. Identical reference signs refer to identical or similar elements. They show:

FIG. 1a-1e a schematic representation of a system with which a method for manufacturing a component from a composite material with locally different thicknesses is produced.

FIG. 2 a schematic representation of the method.

FIG. 3a a detailed illustration of a release layer integrated into a layer structure of a first laminate arrangement.

FIG. 3b shows a release layer arranged on an outermost layer of a first laminate arrangement.

### DETAILED DESCRIPTION OF EXEMPLARY EMBODIMENTS

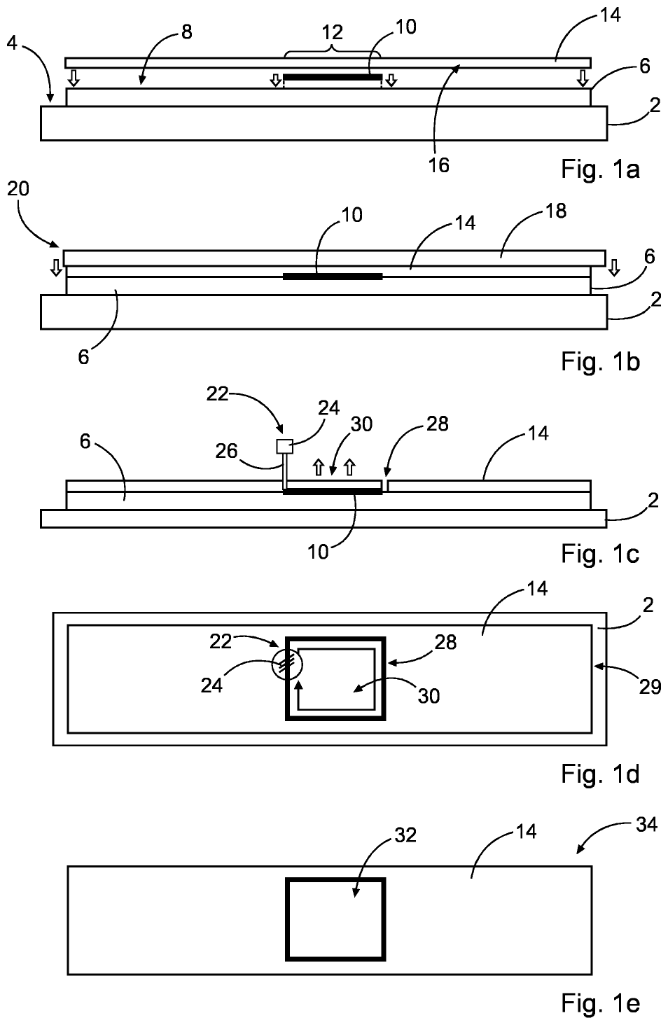

In FIGS. 1a to 1e, a sequence of a method for producing a component from a composite material with locally different thicknesses and a system for producing a component is shown. In FIG. 1a, a molding tool 2 is shown that has a support surface 4. A first laminate arrangement 6 is arranged on this, which has a first surface 8 facing away from the molding tool 2.

A release layer 10 is placed on the first surface 8. The release layer 10 then extends only over a separating section 12 and is designed to prevent a substance-to-substance bond with a second laminate arrangement 14, which is then placed on the first release layer 10. Of course, it is also possible to integrate the release layer 10 into the first laminate arrangement 6 so that it is preferably flush with the first surface 8.

The second laminate arrangement 14 has a second surface 16 facing the first laminate arrangement 6. It is placed on the first surface 8 so that both laminate arrangements 6 and 14 enclose the release layer 10.

FIG. 1b shows the two laminate arrangements 6 and 14 in planar contact with the release layer 10 between them. A cover 18 is positioned on the second laminate arrangement 14 and exerts pressure on the laminate arrangements 6 and 14 in the direction of the molding tool 2. In this example, the cover 18 is rigid and is subjected to a force by an external device not shown.

It could also be provided that the molding tool 2 and/or the cover 18 can be heated. Together with the molding tool 2, the cover 18 forms a joining device 20. In this example, the two laminate arrangements 6 and 14 are fiber-reinforced plastics in which reinforcing fibers are embedded in a thermoplastic matrix material. To join the two laminate arrangements 6 and 14, heating is therefore carried out under a certain pressure so that the matrix material of the two laminate arrangements 6 and 14 melts or softens and a bond is formed at the interface between the first surface 8 and the second surface 16.

In FIG. 1c, the cover 18 is removed. The two laminate arrangements 6 and 14 are connected to each other. A cutting tool 22 with a milling tool 26 driven by a motor 24 is guided along a contour 28 on the second laminate arrangement 14. The contour 28 corresponds to the edge contour of the release layer 10, with the milling tool 26 plunging over an immersion depth that corresponds to a thickness of the second laminate arrangement 14. As the release layer 10 prevents a connection between the first laminate arrangement 6 and the second laminate arrangement 14, a segment 30 is cut out of the second laminate arrangement 14. In FIG. 1d, this is shown in a top view of the second laminate arrangement 14. This illustration also makes it clear that the contour 28 can be positioned completely within the first laminate arrangement 6. The relevant separating section 12 is thus spaced apart from all edges 29 of the first laminate arrangement 6 and the second laminate arrangement 14.

After removing the segment 30, a recess 32 is created in the second laminate arrangement 14 or a component 34, which is formed from the two laminate arrangements 6 and 14. This is shown in FIG. 1e in a plan view. Consequently, this procedure results in a component 34 that has a reduced local thickness.

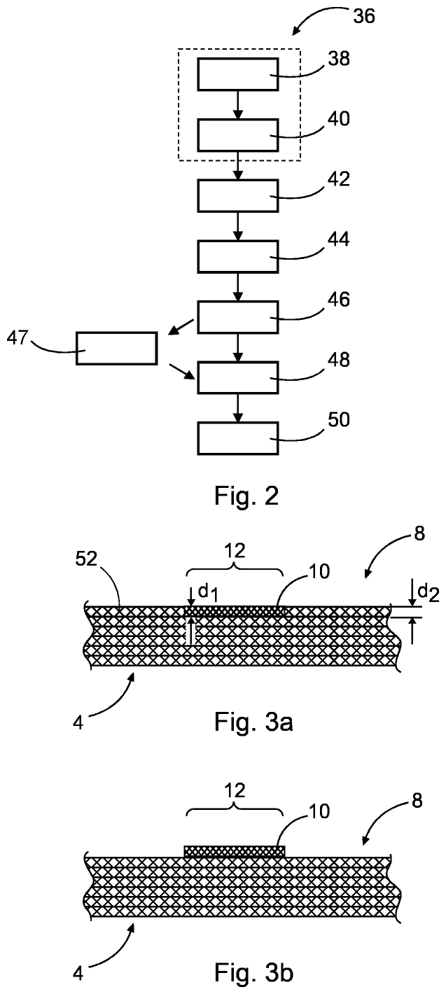

FIG. 2 shows the sequence of the method 36 in a schematic block diagram. The method 36 comprises the steps of providing 38 the first laminate arrangement 6, arranging 40 the release layer 10 on at least one separation portion 12 of the first surface 8 of the first laminate arrangement 6, providing 42 the second laminate arrangement 14 having the second surface 16 which correlates with the first surface 8 of the first laminate arrangement 6, placing 44 the second laminate arrangement 14 with the second surface 16 on the first surface 8 of the first laminate arrangement 6 so that the at least one separation portion 12 is enclosed, the joining 46 of the first laminate arrangement 6 with the second laminate arrangement 14 by heating and/or pressing, the optional forming 47 by a thermoforming process, the guiding 48 of the cutting tool 22 along at least one contour 28 in the second laminate arrangement correlating with the at least one release portion 12, so that at least one segment 30 of the second laminate arrangement 14 is completely released, and the removing 50 of the at least one released segment 30, so that a recess 32 is formed in each case. The arranging 40 of the release layer 10 can already be carried out during the providing 38 of the first laminate arrangement 6, as shown by a dashed box around the two blocks 38 and 40. The providing 38 of the first laminate arrangement 6 or the second laminate arrangement 14 may comprise the providing of a molded fiber body to be infiltrated with a resin. This can take place during the joining 46 by vacuum infusion or an RTM method. Alternatively, the first laminate arrangement 6 and the second laminate arrangement 14 may be pre-impregnated or designed as cured components with a thermoplastic matrix. In the latter embodiment, the laminate arrangements 6 and 14 could be formed from a flat shape into a three-dimensional shape by a thermoforming process if required.

FIG. 3a shows a detailed illustration of a release layer 10 integrated into a layer structure of the first laminate arrangement 4. Here, the release layer 10 has a thickness d1 which corresponds to a thickness d2 of an outermost layer 52 lying on the first surface 8. Thus, the most outward layer 52 and the release layer 10 are flush with each other at the first surface. The most outward layer 52 therefore has a correspondingly dimensioned cut-out into which the release layer 10 is integrated.

In FIG. 3b, however, the release layer 10 is arranged on the outermost layer 52. This can be done very easily and flexibly, especially for test purposes.

In addition, it should be noted that “comprising” or “comprising” does not exclude other elements or steps and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

### LIST OF REFERENCE SIGNS

2 molding tool
4 support surface
6 first laminate arrangement
8 first surface
10 release layer
12 release section
14 second laminate arrangement
16 second surface
18 cover
20 joining device
22 cutting tool
24 motor
26 milling tool
28 contour
29 edge
30 segment
32 recess recess
34 component with locally reduced thickness
36 method
38 providing the first laminate arrangement
40 arranging the release layer
42 providing the second laminate arrangement
44 placing the second laminate arrangement
46 joining the laminate arrangements
47 forming
48 guiding the cutting tool
50 removing the segment
52 most outward layer

1. A method for producing a component from a composite material having locally different thicknesses, comprising the steps of:
providing a first laminate arrangement,
arranging a release layer on at least one separating portion of a first surface of the first laminate arrangement,
providing a second laminate arrangement having a second surface which correlates with the first surface of the first laminate arrangement,
placing the second laminate arrangement with the second surface onto the first surface of the first laminate arrangement, so that the at least one separating section is enclosed,
joining the first laminate arrangement with the second laminate arrangement by heating and/or pressing,
guiding a cutting tool along at least one contour in the second laminate arrangement correlating with the at least one separating portion, so that at least one segment of the second laminate arrangement is completely detached, and
removing the at least one detached segment, so that a recess is formed in each case.

2. The method according to claim 1,
wherein the first laminate arrangement and the second laminate arrangement comprise a fiber-reinforced plastic comprising fibers selected from a group of fibers, said group consisting of:
carbon fibers,
glass fibers,
aramid fibers, and
mixtures of these.

3. The method according to claim 1,
wherein the release layer is incorporated into the first laminate arrangement or the second laminate arrangement so that the release layer is flush with an adjacent material of the first laminate arrangement at the first surface or second surface.

4. The method according to claim 3,
wherein the release layer has a thickness corresponding to a thickness of a layer of the relevant laminate arrangement adjacent to the first surface or the second surface.

5. The method according to claim 1,
wherein the release layer comprises a plastic which is dimensionally stable at temperatures of up to 250° C., at least for a short time.

6. The method according to claim 1,
wherein the release layer comprises an aluminum foil.

7. The method according to claim 1,
wherein the release layer comprises polyimide.

8. The method according to claim 1,
wherein the at least one separating portion is spaced from edges of the first laminate arrangement and the second laminate arrangement.

9. The method according to claim 1,
wherein the joining of the first laminate arrangement with the second laminate arrangement takes place in a thermoforming process.

10. The method according to claim 9, further comprising the step of:
forming by the thermoforming process using a molding tool.

11. A system for manufacturing a component from a composite material having locally different thicknesses, comprising:
a molding tool having a support surface for receiving a first laminate arrangement having a first surface and a second laminate arrangement having a second surface thereon,
a release material configured to be applied to at least one release portion of the first surface of the first laminate arrangement as a release layer,
a joining device adapted to join the superposed first laminate arrangement and second laminate arrangement to the enclosed release material by the action of pressure and/or heat, and
a cutting tool arranged movably relative to the support surface and configured to be guided along at least one contour correlating with the at least one separating section in the second laminate arrangement with a predeterminable immersion depth, so that at least one segment of the second laminate arrangement is completely detached.

12. The system according to claim 11,
wherein the connecting device is configured to exert heat and pressure directed onto the support surface on the laminate arrangements.

13. The system according to claim 11,
wherein the joining device is configured to perform a thermoforming process.

14. The system according to claim 11,
wherein the cutting tool comprises a milling tool.

15. The system according to claim 11,
wherein the connecting device has a cover which, together with the support surface, forms a closed chamber for resin infusion as required.
